(19) United States
(12) Patent Application Publication
(10) Pub. No.: US 2015/0179339 A1
(43) Pub. Date: Jun. 25, 2015

(54) MULTILAYER CERAMIC CAPACITOR

(71) Applicant: SAMSUNG ELECTRO-MECHANICS CO., LTD., Suwon-Si (KR)

(72) Inventors: Byung Kil SEO, Suwon-Si (KR); Je Jung Kim, Suwon-Si (KR); Kang Sun An, Suwon-Si (KR)

(73) Assignee: SAMSUNG ELECTRO-MECHANICS CO., LTD., Suwon-Si (KR)

(21) Appl. No.: 14/225,032

(22) Filed: Mar. 25, 2014

(30) Foreign Application Priority Data
Dec. 20, 2013 (KR) 10-2013-0160364

(51) Int. Cl. H01G 4/005; H01G 4/30; H01G 4/12

(52) U.S. Cl. CPC H01G 4/005; H01G 4/12; H01G 4/30

(57) ABSTRACT

A multilayer ceramic capacitor may include: a ceramic body; first and second external electrodes; first and second internal electrodes; third and fourth internal electrodes being adjacent to the first and second internal electrodes in a thickness direction of the ceramic body, respectively; and first floating electrodes misaligned with the third and fourth internal electrodes in the thickness direction of the ceramic body within the ceramic body and having both end portions overlapped with portions of the third and fourth internal electrodes, respectively. When a distance between the first internal electrode and the third internal electrode or between the second internal electrode and the fourth internal electrode is a and a distance between the third or fourth internal electrode and the first floating electrode is b, b>a may be satisfied.

### CROSS-REFERENCE TO RELATED APPLICATION

This application claims the benefit of Korean Patent Application No. 10-2013-0160364 filed on Dec. 20, 2013, with the Korean Intellectual Property Office, the disclosure of which is incorporated herein by reference.

### BACKGROUND

The present disclosure relates to a multilayer ceramic capacitor.

A multilayer ceramic capacitor (MLCC), which is one of multilayer chip electronic components, is capable of being used in various electronic devices, due to advantages such as a small size, high capacitance, easiness of mounting, or the like.

For example, the multilayer ceramic capacitor is a chip-type condenser that is mounted on printed circuit boards of various electronic products such as display devices including liquid crystal displays (LCDs) and plasma display panels (PDPs), computers, personal digital assistants (PDAs), cell phones, and the like, to allow electricity to be charged therein and discharged therefrom.

In general, a multilayer ceramic capacitor having high voltage and low capacitance characteristics has an internal electrode structure using floating electrodes in order to exhibit the high voltage and the low capacitance characteristics.

For example, in a case in which the multilayer ceramic capacitor having high voltage and low capacitance according to the related art is designed to have an internal electrode structure using floating electrodes so as to obtain low capacitance by stacking a plurality of relatively thick dielectric layers and 10 or less internal electrodes, a buffer layer needs to be additionally inserted between the floating electrode and the internal electrode in order to meet a target capacitance, and thus, an interval between the floating electrode and the internal electrode increases.

However, a final multilayer ceramic capacitor may fail to obtain the target capacitance due to the design of the above-described internal electrode structure using the floating electrodes, and accordingly, manufacturing yield may decrease. In addition, the internal electrode structure using the floating electrodes may reduce the number of internal electrodes having connectivity with external electrodes, whereby conductivity may be deteriorated and equivalent series resistance (ESR) may increase.

### SUMMARY

An aspect of the present disclosure may provide a multilayer ceramic capacitor having high voltage and low capacitance characteristics, in which an internal electrode structure including floating electrodes is used, capable of minutely adjusting capacitance and improving equivalent series resistance (ESR) without increasing a thickness of a dielectric layer or increasing the number of stacked internal electrodes.

According to an aspect of the present disclosure, a multilayer ceramic capacitor may include: a ceramic body having a plurality of dielectric layers stacked therein; first and second external electrodes formed on both end surfaces of the ceramic body, respectively; first and second internal electrodes formed on one dielectric layer to be spaced apart from each other within the ceramic body and exposed through the end surfaces of the ceramic body to be electrically connected to the first and second external electrodes, respectively; third and fourth internal electrodes formed on another dielectric layer to be spaced apart from each other within the ceramic body and exposed through the end surfaces of the ceramic body to be electrically connected to the first and second external electrodes, respectively, the third and fourth internal electrodes being adjacent to the first and second internal electrodes in a thickness direction of the ceramic body, respectively; and first floating electrodes misaligned with the third and fourth internal electrodes in the thickness direction of the ceramic body within the ceramic body and having both end portions overlapped with portions of the third and fourth internal electrodes, respectively, wherein when a distance between the first internal electrode and the third internal electrode or between the second internal electrode and the fourth internal electrode is a and a distance between the third or fourth internal electrode and the first floating electrode is b, b>a may be satisfied.

According to another aspect of the present disclosure, a multilayer ceramic capacitor may include: a ceramic body having a plurality of dielectric layers stacked therein; first and second external electrodes formed on both end surfaces of the ceramic body, respectively; first and second internal electrodes formed on one dielectric layer to be spaced apart from each other within the ceramic body and exposed through the end surfaces of the ceramic body to be electrically connected to the first and second external electrodes, respectively; third and fourth internal electrodes formed on another dielectric layer to be spaced apart from each other within the ceramic body and exposed through the end surfaces of the ceramic body to be electrically connected to the first and second external electrodes, respectively, the third and fourth internal electrodes being adjacent to the first and second internal electrodes in a thickness direction of the ceramic body, respectively; first floating electrodes misaligned with the third and fourth internal electrodes in the thickness direction of the ceramic body within the ceramic body and having both end portions overlapped with portions of the third and fourth internal electrodes, respectively; and third floating electrodes each formed on the dielectric layer having the first and second internal electrodes formed thereon within the ceramic body and spaced apart from the first and second internal electrodes, wherein when a distance between the first internal electrode and the third internal electrode or between the second internal electrode and the fourth internal electrode is a and a distance between the third or fourth internal electrode and the first floating electrode is b, b>a may be satisfied.

A length of an overlap portion between one end portion of the first floating electrode and the third internal electrode may be different from a length of an overlap portion between the other end portion of the first floating electrode and the fourth internal electrode.

A difference between the length of the overlap portion between one end portion of the first floating electrode and the third internal electrode and the length of the overlap portion between the other end portion of the first floating electrode and the fourth internal electrode may be 20% or greater.

The multilayer ceramic capacitor may further include first and second dummy electrodes formed on a dielectric layer having the first floating electrode formed thereon within the ceramic body and exposed through the end surfaces of the ceramic body, respectively.

The multilayer ceramic capacitor may further include second floating electrodes misaligned with the first and second internal electrodes in the thickness direction of the ceramic body within the ceramic body and having both end portions overlapped with portions of the first and second internal electrodes, respectively, the second floating electrodes being adjacent to the first floating electrodes in the thickness direction.

The multilayer ceramic capacitor may further include third and fourth dummy electrodes formed on a dielectric layer having the second floating electrode formed thereon within the ceramic body and exposed through the end surfaces of the ceramic body, respectively.

The multilayer ceramic capacitor may further include fourth floating electrodes each formed on the dielectric layer having the third and fourth internal electrodes formed thereon within the ceramic body and spaced apart from the third and fourth internal electrodes.

### BRIEF DESCRIPTION OF DRAWINGS

The above and other aspects, features and other advantages of the present disclosure will be more clearly understood from the following detailed description taken in conjunction with the accompanying drawings, in which: FIG. 1 is a perspective view schematically showing a multilayer ceramic capacitor according to an exemplary embodiment of the present disclosure;

FIG. 2 is a cross-sectional view taken along line A-A′ of FIG. 1;

FIG. 3 is a cross-sectional view of a multilayer ceramic capacitor according to another exemplary embodiment of the present disclosure; and

FIG. 4 is a graph showing comparison results of equivalent series resistance (ESR) depending on whether or not multilayer ceramic capacitors have a double electrode structure.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

In addition, directions of a multilayer ceramic capacitor according to embodiments of the present disclosure will be defined. L, W and T shown in FIG. 1 refer to a length direction, a width direction, and a thickness direction, respectively.

### Multilayer Ceramic Capacitor

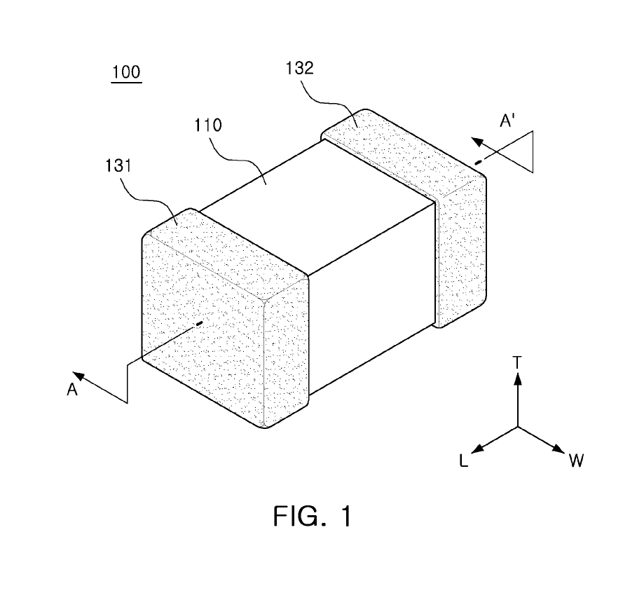

FIG. 1 is a perspective view schematically showing a multilayer ceramic capacitor according to an exemplary embodiment of the present disclosure, and FIG. 2 is a cross-sectional view taken along line A-A′ of FIG. 1.

Referring to FIGS. 1 and 2, a multilayer ceramic capacitor 100 according to an exemplary embodiment of the present disclosure may include a ceramic body 110 having a plurality of dielectric layers 111 stacked therein, first and second external electrodes 131 and 132, a plurality of first and second internal electrodes 121 and 122, a plurality of third and fourth internal electrodes 121′ and 122′, and a plurality of first floating electrodes 123.

Here, when a distance between the first internal electrode 121 and the third internal electrode 121′ or between the second internal electrode 122 and the fourth internal electrode 122′ is a, and a distance between the third internal electrode 121′ or the fourth internal electrode 122′ and the first floating electrode 123 is b, b>a may be satisfied.

The distance a may have an influence on connectivity between the internal electrodes and the external electrodes and equivalent series resistance (ESR) of the multilayer ceramic capacitor, and the distance b may have an influence on withstand voltage and capacitance of the multilayer ceramic capacitor. Here, in the case in which the distance b is smaller than the distance a, reliability may be deteriorated.

The ceramic body 110 may be formed by stacking the plurality of dielectric layers 111 in a thickness direction and then performing a sintering process, wherein adjacent dielectric layers 111 may be integrated such that boundaries therebetween are not readily apparent.

Here, the ceramic body 110 may have a hexahedral shape. In the present embodiment, the ceramic body 110 may have a relatively large size of 16 mm×8 mm or greater, thereby exhibiting high voltage and low capacitance characteristics, but the present disclosure is not limited thereto.

The dielectric layers 111 may contain a ceramic material having high permittivity, for example, a barium titanate (BaTiO₃)-based ceramic powder, and the like. However, the present disclosure is not limited thereto as long as sufficient capacitance may be obtained.

Further, various ceramic additives, an organic solvent, a plasticizer, a binder, a dispersant, or the like, besides the ceramic powder, may be added to the dielectric layers 111, as necessary.

The ceramic additives may include a transition metal oxide or carbide, a rare-earth element, magnesium (Mg), aluminum (Al), and the like, but are not limited thereto.

Referring to FIG. 2, in a cross section of the multilayer ceramic capacitor 100 cut in a length-thickness direction thereof, a portion of the multilayer ceramic capacitor 100 in which the first and second internal electrodes 121 and 122 are not formed may be referred to as a margin portion.

Here, margin portions positioned at upper and lower portions of the ceramic body 110 in a thickness direction thereof may be referred to as upper and lower cover layers, respectively.

The upper and lower cover layers may be formed by sintering a plurality of ceramic sheets, and may have a structure similar to that of the dielectric layer 111 positioned in a central portion of the ceramic body 110 except that the cover layers do not have any internal electrodes formed thereon.

In addition, the first and second external electrodes 131 and 132 may be formed on both end surfaces of the ceramic body 110, respectively, so as to be electrically connected to the first and second internal electrodes 121 and 122 exposed through the end surfaces, respectively.

The first and second external electrodes 131 and 132 may be formed of a conductive metal, for example, at least one of silver (Ag), lead (Pb), platinum (Pt), nickel (Ni), and copper (Cu), and alloys thereof, but are not limited thereto.

Meanwhile, if necessary, first and second plated layers (not shown) may be formed on the first and second external electrodes 131 and 132.

The first and second plated layers each may include a nickel (Ni) plated layer formed on the first and second external electrodes 131 and 132 and a tin (Sn) plated layer formed on the Ni plated layer.

The first and second plated layers are provided to increase adhesion strength between the multilayer ceramic capacitor 100 and a printed circuit board when the multilayer ceramic capacitor 100 is mounted on the printed circuit board, or the like, by using a solder, or the like. The plating process may be performed by a method known in the art, and a lead-free plating process may be advisable in consideration of eco-friendly factors, but the present disclosure is not limited thereto.

The first and second internal electrodes 121 and 122 having opposite polarities may be formed on at least one surface of the same ceramic sheet forming one dielectric layer 111 while being spaced apart from each other within the ceramic body 100, and may be exposed through both end surfaces of the ceramic body 110, respectively.

The first and second internal electrodes 121 and 122 exposed through the respective end surfaces of the ceramic body 110 may be electrically connected to the first and second external electrodes 131 and 132, respectively.

In addition, the first and second internal electrodes 121 and 122 may be formed of a conductive metal, for example, at least one of silver (Ag), lead (Pb), platinum (Pt), nickel (Ni), and copper (Cu), and alloys thereof, but are not limited thereto.

The third and fourth internal electrodes 121′ and 122′ having the same polarity as that of the first and second internal electrodes 121 and 122, respectively, may be formed on at least one surface of the same ceramic sheet forming one dielectric layer 111 while being spaced apart from each other within the ceramic body 100 and may be exposed through the end surfaces of the ceramic body 110, respectively.

In addition, the third and fourth internal electrodes 121′ and 122′ may be adjacent to the first and second internal electrodes 121 and 122, respectively, having at least one dielectric layer 111 interposed therebetween, in the thickness direction of the ceramic body 110, such that the internal electrodes having positive (+) and negative (−) polarities may have a double electrode structure in the thickness direction of the ceramic body 110.

The double electrode structure may improve connectivity between the internal electrodes and the external electrodes to improve ESR of the multilayer ceramic capacitor.

Here, in the case in which a distance between the first and second internal electrodes 121 and 122 and between the third and fourth internal electrodes 121′ and 122′ is extremely large, since it may be difficult to secure low capacitance and reliability of the multilayer ceramic capacitor due to lowered withstand voltage.

The first floating electrodes 123 may serve to provide high capacitance and high reliability to the multilayer ceramic capacitor 100. The first floating electrodes 123 may be misaligned with the third and fourth internal electrodes 121′ and 122′ in the thickness direction of the ceramic body within the ceramic body. Both end portions of the first floating electrode 123 may be overlapped with end portions of the third and fourth internal electrodes 121′ and 122′ spaced apart from each other.

In addition, a length of an overlap portion between one end portion of the first floating electrode 123 and the third internal electrode 121′ may be different from a length of an overlap portion between the other end portion of the first floating electrode 123 and the fourth internal electrode 122′.

Here, a difference between the length of the overlap portion between one end portion of the first floating electrode 123 and the third internal electrode 121′ and the length of the overlap portion between the other end portion of the first floating electrode 123 and the fourth internal electrode 122′ may be 20% or greater.

In the case in which the difference between the length of the overlap portion between one end portion of the first floating electrode 123 and the third internal electrode 121′ and the length of the overlap portion between the other end portion of the first floating electrode 123 and the fourth internal electrode 122′ is less than 20%, when distortion occurs at the time of stacking the internal electrodes, it may be difficult to determine whether the distortion occurs due to low accuracy at the time of stacking the internal electrodes or due to other reasons.

According to the exemplary embodiment of the present disclosure, the capacitance of the multilayer ceramic capacitor may be minutely adjusted such that low capacitance may be obtained by differently adjusting the lengths of the overlap portions between the end portions of the floating electrode and the internal electrodes while having a double electrode structure in which the internal electrodes are disposed to be adjacent to each other in the thickness direction, without increasing the thickness of the dielectric layers or increasing the number of stacked internal electrodes.

In addition, the multilayer ceramic capacitor 100 according to the present embodiment may further include first and second dummy electrodes 124 and 125, as necessary. The first and second dummy electrodes 124 and 125 may be formed on the dielectric layer having the first floating electrode formed thereon within the ceramic body. One edges of the first and second dummy electrodes 124 and 125 maybe exposed through both end surfaces of the ceramic body, respectively.

Meanwhile, the multilayer ceramic capacitor 100 according to the present embodiment may further include second floating electrodes 123′. The second floating electrodes 123′ may be disposed within the ceramic body 110 to be adjacent to the first floating electrodes 123 in the thickness direction of the ceramic body 110.

In addition, the multilayer ceramic capacitor 100 according to the present embodiment may further include third and fourth dummy electrodes 124′ and 125′, as necessary. The third and fourth dummy electrodes 124′ and 125′ may be formed on the dielectric layer having the second floating electrode formed thereon within the ceramic body. One edges of the third and fourth dummy electrodes 124′ and 125′ maybe exposed through both end surfaces of the ceramic body, respectively.

The following Table 1 shows withstand voltage and capacitance fraction of the multilayer ceramic capacitor depending on changes in a and b values when a denotes a distance between the first internal electrode and the third internal electrode or between the second internal electrode and the fourth internal electrode and b denotes a distance between the third or fourth internal electrode and the first floating electrode.

TABLE 1

| | | | Thickness | Thickness | | | | |
|---|---|---|---|---|---|---|---|---|
| | | | of Upper | of Lower | | | | |
| | Size | Number of Stacked | Cover | Cover | | | Withstand | Capacitance |
| # | (mm × mm) | Internal Electrodes | Layer | Layer | a | b | Voltage | Fraction (%) |
| 1 | 16 × 8 | 40 L | 100 um | 100 um | 5 um | 35 um | 4200 V | 100 |
| 2 | 16 × 8 | 40 L | 100 um | 100 um | 10 um | 30 um | 3600 V | 117 |
| 3 | 16 × 8 | 40 L | 100 um | 100 um | 15 um | 25 um | 3000 V | 140 |
| 4 | 16 × 8 | 40 L | 100 um | 100 um | 20 um | 20 um | 2400 V | 175 |
| 5 | 16 × 8 | 40 L | 100 um | 100 um | 25 um | 15 um | 1800 V | 233 |
| 6 | 16 × 8 | 40 L | 100 um | 100 um | 30 um | 7 um | 1200 V | 500 |
| 7 | 16 × 8 | 40 L | 100 um | 100 um | 35 um | 5 um | 600 V | 700 |

The distance a may have an influence on connectivity between the internal electrodes and the external electrodes and the equivalent series resistance (ESR) of the multilayer ceramic capacitor, and the distance b may have an influence on withstand voltage and the capacitance of the multilayer ceramic capacitor.

It could be appreciated from Table 1 that as the distance a becomes increased and the distance b becomes decreased, high capacitance is secured; however, withstand voltage is deteriorated, and thus, it may be difficult to secure reliability of the multilayer ceramic capacitor.

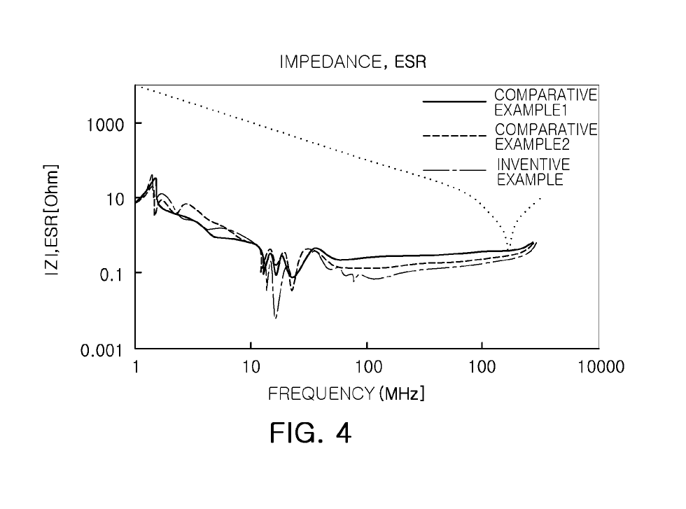

FIG. 4 is a graph showing comparison results of ESR between a multilayer ceramic capacitor according to the related art and a multilayer ceramic capacitor according to an exemplary embodiment of the present disclosure. Here, the multilayer ceramic capacitor according to the related art does not have a double electrode structure, while the multilayer ceramic capacitor according to the exemplary embodiment of the present disclosure has a double electrode structure.

Here, Comparative Example 1 shows ESR of a multilayer ceramic capacitor in which both end portions of a floating electrode overlapped with internal electrodes have the same length, Comparative Example 2 shows ESR of a multilayer ceramic capacitor in which both end portions of a floating electrode overlapped with internal electrodes have different lengths, and an Inventive Example shows ESR of a multilayer ceramic capacitor in which both end portions of a floating electrode overlapped with internal electrodes have different lengths and the internal electrodes have a double electrode structure.

With reference to FIG. 4, it could be appreciated that connectivity between the internal electrodes and external electrodes is improved in Inventive Example as compared to Comparative Examples 1 and 2, whereby the ESR may be improved. Here, a dotted line shows impedance.

### MODIFIED EXAMPLE

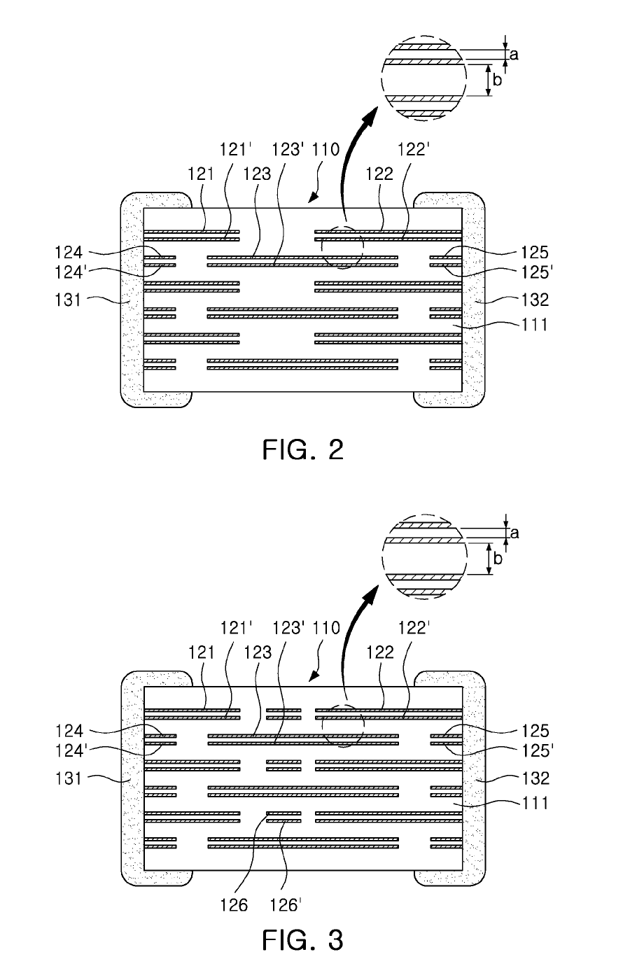

FIG. 3 is a cross-sectional view of a multilayer ceramic capacitor according to another exemplary embodiment of the present disclosure.

Here, since the multilayer ceramic capacitor according to the present embodiment have the same structure including the ceramic body 110, the first and second external electrodes 131 and 132, the first and second internal electrodes 121 and 122, the third and fourth internal electrodes 121′ and 122′, and the first floating electrodes 123, as that of the multilayer ceramic capacitor described in the previous embodiment of the present disclosure, a detailed description thereof will be omitted.

In the present embodiment, additional components may be included in the multilayer ceramic capacitor according to the previous embodiment of the present disclosure. That is, a third floating electrode 126 may be formed on the dielectric layer 111 having the first and second internal electrodes 121 and 122 formed thereon within the ceramic body 110 while being spaced apart from the first and second internal electrodes 121 and 122.

In addition, the multilayer ceramic capacitor according to the present embodiment may further include a fourth floating electrode 126′. The fourth floating electrode 126′ may be formed on the dielectric layer 111 having the third and fourth internal electrodes 121′ and 122′ formed thereon within the ceramic body 110 while being spaced apart from the third and fourth internal electrodes 121′ and 122′.

Here, the third floating electrode 126 and the fourth floating electrode 126′ may have the same length, and have the same overlap area in the thickness direction, but the present disclosure is not limited thereto.

As set forth above, in a multilayer ceramic capacitor having high voltage and low capacitance characteristics according to exemplary embodiments of the present disclosure, internal electrodes and floating electrodes are provided to have a double electrode structure while both end portions of the floating electrode overlapped with the internal electrodes are adjusted to have different lengths. Therefore, without increasing the thickness of dielectric layers or increasing the number of stacked internal electrodes, capacitance of the multilayer ceramic capacitor may be minutely adjusted such that low capacitance may be obtained, and connectivity between internal electrodes and external electrodes may be improved due to the double electrode structure, whereby ESR may be improved.

While exemplary embodiments have been shown and described above, it will be apparent to those skilled in the art that modifications and variations could be made without departing from the spirit and scope of the present disclosure as defined by the appended claims.

What is claimed is:

1. A multilayer ceramic capacitor comprising:
a ceramic body having a plurality of dielectric layers stacked therein;
first and second external electrodes disposed on end surfaces of the ceramic body, respectively;
first and second internal electrodes disposed on one dielectric layer to be spaced apart from each other within the ceramic body and extended through the end surfaces of the ceramic body to be electrically connected to the first and second external electrodes, respectively;
third and fourth internal electrodes disposed on another dielectric layer to be spaced apart from each other within the ceramic body and extended through the end surfaces of the ceramic body to be electrically connected to the first and second external electrodes, respectively, the third and fourth internal electrodes being adjacent to the first and second internal electrodes in a thickness direction of the ceramic body, respectively; and
first floating electrodes misaligned with the third and fourth internal electrodes in the thickness direction of the ceramic body within the ceramic body and having end portions overlapped with portions of the third and fourth internal electrodes, respectively,
wherein when a distance between the first internal electrode and the third internal electrode or between the second internal electrode and the fourth internal electrode is a and a distance between the third or fourth internal electrode and the first floating electrode is b, b>a is satisfied.

2. The multilayer ceramic capacitor of claim 1, wherein a length of an overlap portion between one end portion of the first floating electrode and the third internal electrode is different from a length of an overlap portion between the other end portion of the first floating electrode and the fourth internal electrode.

3. The multilayer ceramic capacitor of claim 2, wherein a difference between the length of the overlap portion between one end portion of the first floating electrode and the third internal electrode and the length of the overlap portion between the other end portion of the first floating electrode and the fourth internal electrode is 20% or greater.

4. The multilayer ceramic capacitor of claim 1, further comprising first and second dummy electrodes formed on a dielectric layer having the first floating electrode formed thereon within the ceramic body and exposed through the end surfaces of the ceramic body, respectively.

5. The multilayer ceramic capacitor of claim 1, further comprising second floating electrodes misaligned with the first and second internal electrodes in the thickness direction of the ceramic body within the ceramic body and having both end portions overlapped with portions of the first and second internal electrodes, respectively, the second floating electrodes being adjacent to the first floating electrodes in the thickness direction.

6. The multilayer ceramic capacitor of claim 5, further comprising third and fourth dummy electrodes formed on a dielectric layer having the second floating electrode formed thereon within the ceramic body and exposed through the end surfaces of the ceramic body, respectively.

7. A multilayer ceramic capacitor comprising:
a ceramic body having a plurality of dielectric layers stacked therein;
first and second external electrodes disposed on end surfaces of the ceramic body, respectively;
first and second internal electrodes disposed on one dielectric layer to be spaced apart from each other within the ceramic body and exposed through the end surfaces of the ceramic body to be electrically connected to the first and second external electrodes, respectively;
third and fourth internal electrodes disposed on another dielectric layer to be spaced apart from each other within the ceramic body and extended through the end surfaces of the ceramic body to be electrically connected to the first and second external electrodes, respectively, the third and fourth internal electrodes being adjacent to the first and second internal electrodes in a thickness direction of the ceramic body, respectively;
first floating electrodes misaligned with the third and fourth internal electrodes in the thickness direction of the ceramic body within the ceramic body and having end portions overlapped with portions of the third and fourth internal electrodes, respectively; and
third floating electrodes each disposed on the dielectric layer having the first and second internal electrodes disposed thereon within the ceramic body and spaced apart from the first and second internal electrodes,
wherein when a distance between the first internal electrode and the third internal electrode or between the second internal electrode and the fourth internal electrode is a and a distance between the third or fourth internal electrode and the first floating electrode is b, b>a is satisfied.

8. The multilayer ceramic capacitor of claim 7, wherein a length of an overlap portion between one end portion of the first floating electrode and the third internal electrode is different from a length of an overlap portion between the other end portion of the first floating electrode and the fourth internal electrode.

9. The multilayer ceramic capacitor of claim 8, wherein a difference between the length of the overlap portion between one end portion of the first floating electrode and the third internal electrode and the length of the overlap portion between the other end portion of the first floating electrode and the fourth internal electrode is 20% or greater.

10. The multilayer ceramic capacitor of claim 7, further comprising first and second dummy electrodes formed on a dielectric layer having the first floating electrode formed thereon within the ceramic body and exposed through the end surfaces of the ceramic body, respectively.

11. The multilayer ceramic capacitor of claim 7, further comprising second floating electrodes misaligned with the first and second internal electrodes in the thickness direction of the ceramic body and having both end portions overlapped with portions of the first and second internal electrodes, respectively, the second floating electrodes being adjacent to the first floating electrodes in the thickness direction.

12. The multilayer ceramic capacitor of claim 11, further comprising third and fourth dummy electrodes formed on a dielectric layer having the second floating electrode formed thereon within the ceramic body and exposed through the end surfaces of the ceramic body, respectively.

13. The multilayer ceramic capacitor of claim 7, further comprising fourth floating electrodes each formed on the dielectric layer having the third and fourth internal electrodes formed thereon within the ceramic body and spaced apart from the third and fourth internal electrodes.
